(19) United States
(12) Patent Application Publication
(10) Pub. No.: US 2008/0157034 A1
(43) Pub. Date: Jul. 3, 2008

(54) Modified acrylic resin and optical diffusing composition utilizing the same

(75) Inventors: Pei-Chi Chien, Yilan County (TW); Yaw-Ting Wu, Taoyuan County (TW); Wen-Hsien Wang, Tainan County (TW); Chun-Hsiang Wen, Hsinchu-City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/822,361

(22) Filed: Jul. 5, 2007

(30) Foreign Application Priority Data
Dec. 28, 2006 (TW) 95149461

(51) Int. Cl. G02B 5/02; C08F 20/10

(52) U.S. Cl. 252/582; 526/318

(57) ABSTRACT

A modified acrylic resin. The modified acrylic resin comprises a transparent resin and an acrylic acid monomer having a cyclic group, and the modified acrylic resin has a low moisture adsorption. Additionally, the modified acrylic resin can be incorporated with light scattering particle and light stabilizer to provide an optical diffusing composition for use in backlight module of LCD panels.

### BACKGROUND OF THE INVENTION

1. Field of the Invention

The present invention relates to acrylic resin, and in particular relates to low moisture absorptive acrylic resin.

2. Description of the Related Art

Liquid crystal display (LCD) panels are currently applied to notebook computers and televisions. A backlight module works as a light source in a LCD, and a diffusing material is used to improve the diffusion and uniformity of light. Thus, the quality of the diffusing material directly affects the capacity of the backlight module and the reliability of the products. Generally, to obtain high transmittance and diffusion properties, a highly transparent resin can be used, such as poly(methyl methacrylate) (PMMA), polycarbonate (PC), polyurethane (PU), wherein the PMMA has advantages of high transmittance and low cost so that PMMA is extensively used.

In, 1993, Nikkei Electronics disclosed a diffusing material comprising an organic substrate coated with an organic PMMA resin and organic particles. However, the organic particle has a large diameter, the weight ratio of the organic particle to the organic PMMA is low, and the light transmission of the diffusing composition is low.

As disclosed in U.S. Pat. No. 5,607,764, a PMMA organic particle having a 10-20 μm diameter is coated to a diffusing layer, and the RI and weight ratio of the organic particle to the adhesive is regulated to improve haze and transmittance. Although the PMMA particle and PMMA adhesive form high optical quality products, the PMMA has the disadvantages of low moisture adsorption and low light stability.

To enhance the light stability of PMMA, U.S. Pat. No. 6,723,772 discloses addition of a UV absorbent to improve resistance to UV radiation. However, the functional groups of PMMA exhibit high moisture adsorption, resulting in deformation and property changes of the PMMA.

To improve the optical properties and the reliability of the LCD, an optical diffusing composition having high transmittance and low moisture adsorption is needed.

### BRIEF SUMMARY OF INVENTION

The invention provides an optical diffusing composition with high transmittance and low moisture adsorption to improve the optical properties and the reliability of LCD.

In an embodiment, the invention provides a modified acrylic acid comprising the repeat unit of the repeat unit (I) and repeat unit (II):

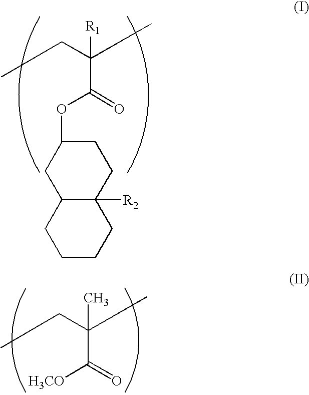

wherein the weight ratio of repeat unit (I) to repeat unit (II) is between 5% and 80%, and the R1 and R2 each independently represent a hydrogen or alkyl group.

In another embodiment, the invention provides an optical diffusing composition, comprising a modified acrylic resin, a light scattering particle, and a light stabilizer, wherein the weight ratio of the light scattering particle is between 0.1 wt % and 20 wt %, the weight ratio of the light stabilizer is between 0.01 wt % and 0.5 wt %, the weight ratio of the modified acrylic resin is between 79 wt % and 99.8 wt, and the modified acrylic resin comprises the repeat unit of the repeat unit (I) and repeat unit (II):

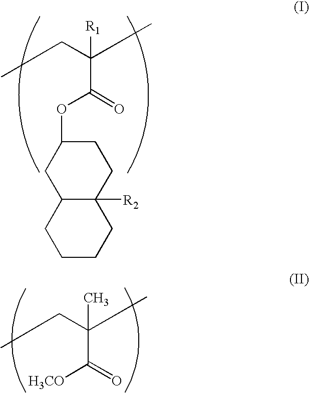

wherein the weight ratio of repeat unit (I) to repeat unit (II) is between 5% and 80%, and R1 and R2 each independently represent a hydrogen or alkyl group.

A detailed description is given in the following embodiments with reference to the accompanying drawings.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a modified acrylic resin. In the synthesis procedure, an acrylic monomer having a cyclic group is added to form a transparent resin having low moisture adsorption.

In the invention, the modified acrylic resin is formed by two kinds of monomer, wherein the one monomer is a resin, preferably a transparent resin, such as poly(methyl methacrylate) (PMMA), polycarbonate (PC), polyurethane (PU). Another monomer is a compound having a cyclic group, such as 2-decahydronaphthyl methacrylate (2-DHM), 2-decahydronaphthyl acrylate (2-DHA).

The modified acrylic resin of the invention comprises the repeat unit of repeat unit (I) and repeat unit (II):

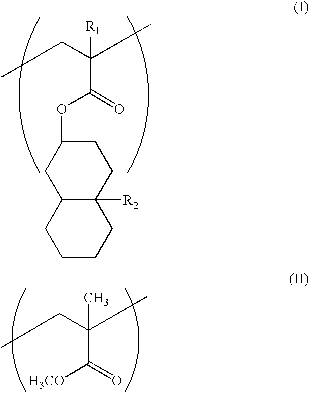

wherein R1 and R2 each independently represent a hydrogen or alkyl group. The repeat unit (I) is a compound having a cyclic group, and the repeat unit (II) is a transparent resin. The weight ratio of the repeat unit (I) to the repeat unit (II) is about 5% to 80%, or 5% to 60%, preferably 10% to 50%. The refractive index of the modified acrylic resin is between 1.4 and 1.7, or 1.5 and 1.6. The water contact angle of the modified acrylic resin exceeds 70°, preferably 80°. The water absorption rate of the modified acrylic resin is below 0.3%, or 0.2%. The weight average molecular weight of the modified acrylic resin is between 50,000 and 200,000, preferably 10,000 and 2000,000.

The modified acrylic resin can be incorporated with light scattering particle and light stabilizer to provide an optical diffusing composition for use in backlight module of LCD panels. The light scattering particle or the light stabilizer may be selected from any suitable material. For example, the light scattering particle can comprise polystyrene, calcium carbonate, silica, titanium dioxide, acrylic acid, silicone, or polyethylene, and the light scattering particle has a diameter between 0.1 and 30 μm, or 1 and 20 μm. The weight ratio of the light scattering particle is between 0.1 wt % and 20 wt %, or 0.5% and 10%. The light stabilizer comprises hydroquinone, benzophenone, benzotriazole, or hindered amine light stabilizer (HALS), and the weight ratio of the light stabilizer is between 0.01 wt % and 0.5 wt %, or 0.01 and 0.1 wt %. The optical diffusing composition comprises the light scattring particle of 0.1 to 20 wt %, light stabilizer of 0.01 to 0.5 wt %, and modified acrylic resin of 79 to 99.8 wt %. The water absorption rate of the optical diffusing composition is below 0.3%, or 0.2%, and the transmittance is between 80% and 95%, or 90% and 95%.

The modified acrylic resin of the invention has a high transmittance level and a low water absorption rate, and the modified acrylic resin can be incorporated with light scattering particles and light stabilizer to provide an optical diffusing composition for use in backlight module of LCD panels.

### EXAMPLE

### Example 1

### Synthesis of 2-DHM20/MMA80 copolymer

In the presence of nitrogen, 10.18 g of 2-decahydronaphthyl methacrylate (0.0458 mole, 97%), 39.96 g of methyl methacylate (0.2991 mole, 98.5%), 0.158 g of benzoperoxide initiator, and 90 g of toluene were added into a reactor and mixed until the benzoperoxide initiator was completely dissolved to form a mixture. After the dissolution of the benzoperoxide initiator, the reactor was heated at 80° C., and the mixture was continually stirred for 10 hours to form 2-DHM20/MMA80 copolymer. Finally, the physical and chemical properties of 2-DHM20/MMA80 copolymer were analyzed at 25° C., the results are listed in table 1.

### Example 2

### Synthesis of 2-DHM40/MMA60 copolymer

In the presence of nitrogen, 20.15 g of 2-decahydronaphthyl methacrylate (0.0458 mole, 97%), 29.99 g of methyl methacylate (0.2991 mole, 98.5%), 0.158 g of benzoperoxide initiator, and 90 g of toluene were added into a reactor and mixed until the benzoperoxide initiator was completely dissolved to form a mixture. After the dissolution of the benzoperoxide initiator, the reactor was heated at 80° C., and the mixture was continually stirred for 10 hours to form 2-DHM20/MMA80 copolymer. Finally, the physical and chemical properties of 2-DHM20/MMA80 copolymer were analyzed at 25° C., the results are listed in Table 1.

TABLE 1
Physical properties of the copolymer

| | Polymethyl | | |
|---|---|---|---|
| | methacrylate | 2-DHM20/MMA80 | 2-DHM40/MMA60 |
| | (PMMA) | copolymer | copolymer |
| Tg(° C.) | 78° C. | 128° C. | 156° C. |
| TGA (5% | 275° C. | 231° C. | 190° C. |
| weight lose) | | | |
| NMR | δ3.564(s)-CH3 | δ4.9-4.4(d)0-C—H | δ4.9-4.4(d)-C—H |
| | | δ3.566(s)-CH3 | δ3.659(s)-CH3 |
| Contact | 75.233° | 81.667° | 86.767° |
| angle | | | |
| Water | 1.37% | 0.1786% | 0.0848% |
| absorption | | | |
| Mw | 110165 | 110649 | 129249 |
| Mw/Mn | 7.17 | 4.47668 | 2.30026 |

Tg: glass transition temperature;
TGA: thermogravimetric analysis;
Mw: molecular weight

### Example 3

### Synthesis of Optical Diffusing Composition

5 g of 2-DHM20/MMA80 copolymer of Example 1, 0.5 g of organic particle (SBX-6, Seikisui), 0.0025 g of hydroquenione (99%, Aldrich), and toluene solution were mixed and then applied to the surface of optical grade polyethylene terephthalate. After heating at 80° C. for 30 min, the optical diffusing composition of the invention was formed, and the transmittance of the optical diffusing composition exceeded 90%.

### Example 4

### Synthesis of Optical Diffusing Composition

5 g of 2-DHM20/MMA80 copolymer of Example 1, 0.5 g of inorganic particle SiO2(MA1010, ALFA Co.), 0.0025 g of hydroquenione (99%, Aldrich), and toluene solution were mixed and then applied to the surface of optical grade polyethylene terephthalate. After heating at 80° C. for 30 min, the optical diffusing composition of the invention was formed, and the transmittance of the optical diffusing composition exceeded 90%.

| | Example3(SBX-6) | Example4(MA1010) | Commerical AP012 |
|---|---|---|---|
| Haze % | 84.55 | 80.83 | 60.84 |
| TT % | 97.5 | 98.4 | 83.26 |
| DF | 6.59 | 15.14 | 0.6 |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A modified acrylic resin, comprising repeat unit (I) and repeat unit (II): 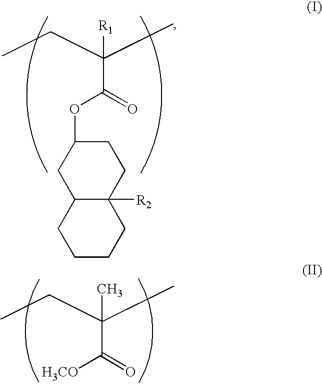
wherein the weight ratio of the repeat unit (I) to repeat unit (II) is between 5% and 80%, and R1 and R2 each independently represent a hydrogen or alkyl group.

2. The modified acrylic resin as claimed in claim 1, wherein the repeat unit (I) contains a cyclic group.

3. The modified acrylic resin as claimed in claim 1, wherein the repeat unit (II) is an acrylic resin.

4. The modified acrylic resin as claimed in claim 1, wherein the modified acrylic resin is a copolymer of 2-decahydronaphthyl methacrylate (2-DHM) and methyl methacylate (MMA).

5. The modified acrylic resin as claimed in claim 1, wherein the refractive index of the modified acrylic resin is between 1.4 and 1.7.

6. The modified acrylic resin as claimed in claim 1, wherein a weight average molecular weight of the modified acrylic resin is between 10,000 and 200,000.

7. An optical diffusing composition, comprising 79 wt % to 99.8 wt % of a modified acrylic resin, 0.1 wt % to 20 wt % of a light scattering particle, and 0.01 wt % to 0.5 wt % of a light stabilizer, the modified acrylic resin comprises a repeat unit of repeat unit (I) and repeat unit (II): 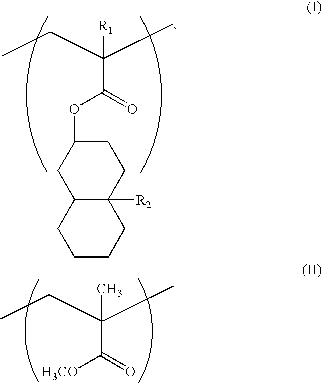
wherein a weight ratio of the repeat unit (I) to the repeat unit (II) is between 5% and 80%, and R1 and R2 each independently represent a hydrogen or alkyl group.

8. The optical diffusing composition as claimed in claim 7, wherein the repeat unit (I) contains a cyclic group.

9. The optical diffusing composition as claimed in claim 7, wherein the repeat unit (II) is an acrylic resin.

10. The optical diffusing composition as claimed in claim 7, wherein the modified acrylic resin is a copolymer of 2-decahydronaphthyl methacrylate (2-DHM) or methyl methacylate (MMA).

11. The optical diffusing composition as claimed in claim 7, wherein a refractive index of the modified acrylic resin is between 1.4 and 1.7.

12. The optical diffusing composition as claimed in claim 7, wherein a weight average molecular weight of the modified acrylic resin is between 10,000 and 200,000.

13. The optical diffusing composition as claimed in claim 7, wherein the light scattering particle comprises polystyrene, calcium carbonate, silica, titanium dioxide, acrylic acid, silicone, or polyethylene.

14. The optical diffusing composition as claimed in claim 7, wherein the light scattering particle has a diameter between about 0.1 and 20 μm.

15. The optical diffusing composition as claimed in claim 7, wherein the light stabilizer comprises hydroquinone, benzophenone, benzotriazole, or hindered amine light stabilizer (HALS).
